(19) United States
(12) Patent Application Publication
(10) Pub. No.: US 2013/0334437 A1
(43) Pub. Date: Dec. 19, 2013

(54) ELECTROSTATIC LENS AND METHOD OF MANUFACTURING THE SAME

(71) Applicant: CANON KABUSHIKI KAISHA, Tokyo (JP)

(72) Inventors: Tadayuki Yoshitake, Tokyo (JP); Yoichi Ando, Inagi-shi (JP)

(73) Assignee: CANON KABUSHIKI KAISHA, Tokyo (JP)

(21) Appl. No.: 13/900,947

(22) Filed: May 23, 2013

(30) Foreign Application Priority Data
Jun. 15, 2012 (JP) 2012-135672

(51) Int. Cl. H01J 29/62; H01J 9/18

(52) U.S. Cl. CPC H01J 29/62; H01J 9/18
USPC 250/396 R; 29/610.1

(57) ABSTRACT

An electrostatic lens includes a first electrode and a second electrode that are arranged oppositely relative to each other with a gap separating them from each other and the first and second electrodes have respective through-holes for allowing a charged particle beam to pass through the through-hole, wherein at least either the first electrode or the second electrode comprises two or more regions; and the through-hole of the electrode with the two or more regions is arranged at least in one of the regions; while the regions are electrically connected to each other by way of a resistor.

### BACKGROUND OF THE INVENTION

1. Field of the Invention

The present invention relates to an electrostatic lens to be used in an apparatus that uses a charged particle beam such as an electron beam and also to a method of manufacturing such a lens.

2. Description of the Related Art

An electron beam needs to be highly precisely converged to a micro region to realize a micro pattern exposure in an electron beam exposure system. Thus, an electron lens takes a very important role because it is a device that can operate to cause an electron beam to converge. As electron lenses, electrostatic lenses that operate to cause an electron beam to converge when a high voltage is applied to the electrodes thereof are being popularly employed.

An electrostatic lens is mostly operated in a vacuum container in order to avoid collisions of electrons and air molecules.

However, as a high voltage is applied to an electrostatic lens, an electric discharge can take place, originating from surface degassing of an insulator or some other member of the lens, a dust or a defect of a member of the lens.

Once an electric discharge occurs, the electric charges accumulated in the electrodes, the cables and the capacitors flow to the discharging spot to give rise to a large electric current that by turn damages the lens electrodes, the power source and other related electronic devices.

Japanese Patent Application Laid-Open No. 2002-100317 discloses a technique of arranging a current limiting resistor in a circuit in order to suppress the large electric current caused to flow as a result of an electric discharge.

As the trend of higher precision control of electron beams has been accelerated in recent years, electron beams are required to converge to a smaller micro region. As a result, the gap separating the electrodes for generating a high electric field is required to become smaller. The electrodes having a small gap separating them inevitably possess a large electrostatic capacity and hence, once an electric discharge occurs, the electric charge accumulated there because of the large electrostatic capacity of the electrodes suddenly flows to give rise to an instantaneous large electric current.

Such a large electric current causes the metal of the electrodes to evaporate and the electric discharge is maintained by the generated metal vapor to give rise to a continuous electric discharge. As a continuous electric discharge occurs, the duration of the electric discharge is prolonged to severely damage the electrodes and other members.

In such a situation, the above-cited known current limiting technique cannot suppress the discharge current caused by the electric charge accumulated in the electrodes themselves because the current limiting resistor is arranged outside the electrodes.

In view of the above-identified problem, the object of the present invention is to provide an electrostatic lens that can suppress the discharge current that flows at the time of an electric discharge, thereby suppressing the degradation of the lens members, so as to provide the lens with an improved reliability, and also a method of manufacturing such a lens.

### SUMMARY OF THE INVENTION

According to the present invention, there is provided an electrostatic lens including: a first electrode; and a second electrode; the first electrode and the second electrode being arranged oppositely relative to each other with a gap separating them from each other; the first and second electrodes having respective through-holes for allowing a charged particle beam to pass through the through-hole; at least either the first electrode or the second electrode comprising two or more regions; the through-hole of the electrode with the two or more regions being arranged at least in one of the regions; the regions being electrically connected to each other by way of a resistor.

Further features of the present invention will become apparent from the following description of exemplary embodiments with reference to the attached drawings.

### BRIEF DESCRIPTION OF THE DRAWINGS

FIGS. 1A and 1B are a schematic plan view and a schematic cross-sectional view of an electrostatic lens according to the present invention, illustrating the configuration thereof;

FIG. 2 is a schematic plan view of an electrostatic lens according to the present invention, illustrating an alternative configuration of the electrodes thereof;

FIGS. 3A, 3B, 3C and 3D are schematic plan view of an electrostatic lens according to the present invention, illustrating other alternative configurations of the electrodes thereof;

FIGS. 4A, 4B, 4C and 4D are cross-sectional views of an electrostatic lens according to the present invention, illustrating alternative configurations of the resistor thereof;

FIG. 5 is a schematic cross-sectional view of an electrostatic lens according to the present invention, illustrating another alternative configuration of the resistor thereof;

FIGS. 6A, 6B, 6C, 6D, 6E, 6F, 6G and 6H are schematic cross-sectional views of the electrostatic lens of Example 1, illustrating the flow of the manufacturing process thereof;

FIGS. 7A, 7B, 7C, 7D, 7E and 7F are schematic cross-sectional views of the electrostatic lens of Example 1, illustrating the flow of the manufacturing process thereof;

FIGS. 8A, 8B, 8C, 8D, 8E, 8F, 8G and 8H are schematic cross-sectional views of the electrostatic lens of Example 2, illustrating the flow of the manufacturing process thereof;

FIGS. 9A, 9B, 9C, 9D, 9E and 9F are schematic cross-sectional views of the electrostatic lens of Example 3, illustrating the flow of the manufacturing process thereof; and

FIGS. 10A, 10B, 10C, 10D and 10E are schematic cross-sectional views of the electrostatic lens of Example 4, illustrating the flow of the manufacturing process thereof.

### DESCRIPTION OF THE EMBODIMENTS

Preferred embodiments of the present invention will now be described in detail in accordance with the accompanying drawings.

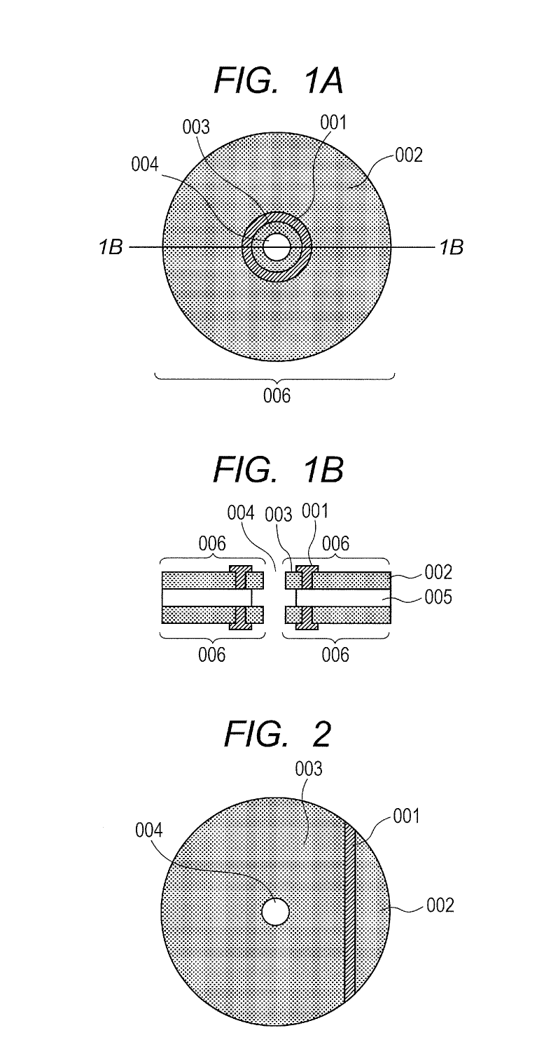

Now, an exemplar configuration of an electrostatic lens according to the present embodiment will be described below by referring to FIGS. 1A, and 1B through 5.

The electrostatic lens includes a first electrode and a second electrode that are arranged oppositely relative to each other with a gap separating them and each of the first and second electrodes has one or more through-holes so as to allow a charged particle beam to pass through it.

FIG. 1A is a schematic plan view of the electrostatic lens. Referring to FIG. 1A, each of the electrodes 006 is divided into region A 002 and region B 003 and a resistor region 001 is interposed between the two electrode regions. Through-hole 004 is arranged in the region B 003 so as to allow an charged particle beam wholly or partly pass through the through-hole 004. Of the paired electrodes 006, the first electrode corresponds to the upper electrode and the second electrode corresponds to the lower electrode.

FIG. 1B is a schematic cross-sectional view taken along line 1B-1B in FIG. 1A. The paired electrodes 006 are arranged vis-a-vis with a support member 005 interposed between them. Each of the electrodes 006 is divided into region A 002 and region B 003 and a resistor is arranged in the portion (resistor region) 001 between the two regions produced as a result of the division.

The support member 005 arranged between the first electrode and the second electrode is preferably made of an insulating material such as glass or ceramic.

The support member 005 may be replaced by a vacuum region interposed between the two electrodes.

While the resistor region 001 is arranged so as to surround the through-hole 004 in FIG. 1A, each of the electrodes may alternatively be divided in a different manner. For example, at least one of the electrodes may be divided by a straight line as illustrated in FIG. 2.

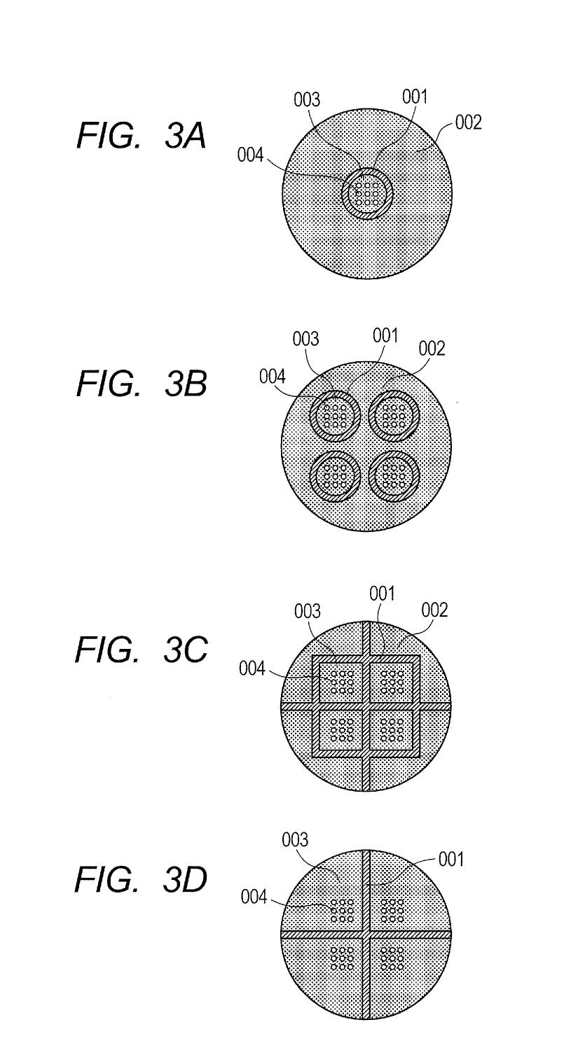

While a single through-hole is formed in each of the electrodes in FIGS. 1A, 1B and 2, a plurality of through-holes 004 may be formed as illustrated in FIG. 3A.

Additionally, as illustrated in FIG. 3B, a plurality of regions, each of which includes one or more through-holes, may be provided so as to correspond to the region B 003 that includes a through-hole 004. Similarly, as illustrated in FIG. 3C, a plurality of regions, each of which does not include any through-hole, may be provided so as to correspond to the region A 002 that does not include any through-hole.

Alternatively, as illustrated in FIG. 3D, each of the electrodes may be made to include only a region that includes a through-hole and corresponds to the region B 003 that includes a through-hole.

The through-holes 004 are preferably round holes, although they may have a different profile.

In FIG. 1B, the resistor regions 001 are made to represent a profile of projecting to the outside of the outer surface of the region A 002 and also to the outside of the outer surface of the region B 003. Such a profile can effectively suppress any creeping discharge that can arise when an electric discharge occurs and a potential difference is produced between the region A 002 and the region B 003.

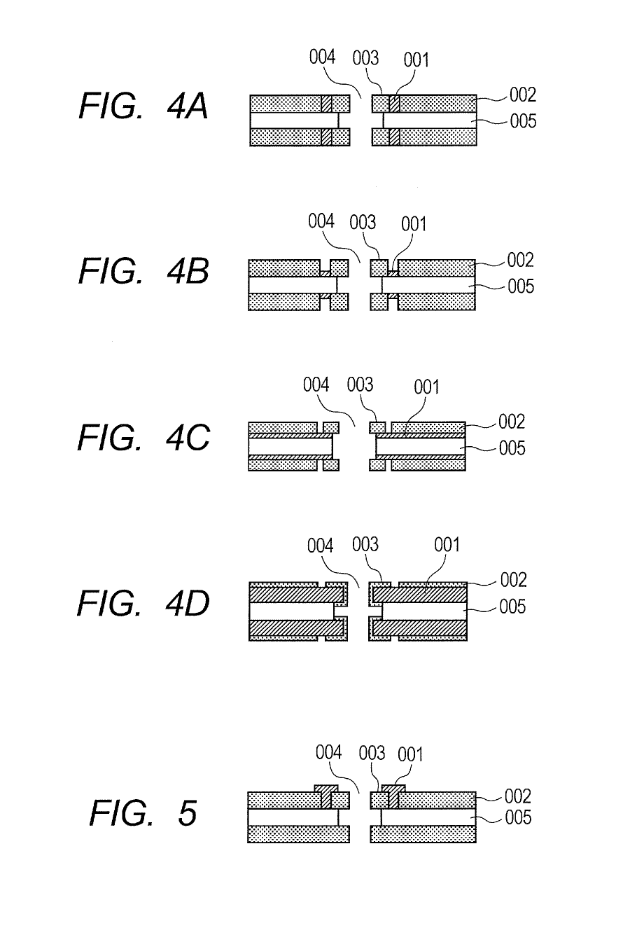

For each of the electrodes, the resistor region 001 may be made to have a thickness same as the thickness of the region A 002 and that of the region B 003 as illustrated in FIG. 4A. Alternatively, for each of the electrodes, the resistor region 001 may be made to be thinner than the region A 002 and the region B 003 as illustrated in FIG. 4B.

Still alternatively, for each of the electrodes, both the region A 002 and the region B 003 may be arranged on a resistor region 001 as illustrated in FIGS. 4C and 4D. With such an arrangement, the resistor region 001 may be arranged on both surfaces of the region A 002 and that of the region B 003 or on one surface of the region A 002 and that of the region B 003.

While both of the paired electrodes are provided with a resistor region 001 in FIGS. 1A, 1B and 4A through 4D, only one of the paired electrodes may alternatively be provided with a resistor region as illustrated in FIG. 5 if manufacturing paired electrodes, both of which are provided with a resistor region, entails difficulties in terms of process matching with other component members. A discharge current suppressing effect can be realized if only one of the paired electrodes is provided with a resistor region.

The range of electric resistance value of the resistor region needs to be sufficiently higher than the range of electric resistance value of the electrode material in order to achieve a satisfactory discharge current suppressing effect.

The range of electric resistance value of the resistor region needs to be sufficiently smaller than the electric resistance of the support member so that the resistor region may not interfere with the operation of controlling the electric potentials of the electrodes.

A low resistance material representing an electric resistivity of not higher than about 1×10²Ω·cm is preferably used as electrode material so as to avoid being electrically charged by recoil electrons and any others and not to disturb the electric field distribution at and near the through-holes 004.

The support member is preferably made of a material having a high dielectric withstanding such as glass because the support member is required to represent a satisfactory dielectric withstanding against the high electric field to be applied to the member. The support member preferably represents an electric resistivity value of not less than about 1×10¹²Ω·cm.

Thus, a material representing an electric resistivity value between about 1×10⁴Ω·cm and 1×10¹⁰Ω·cm is preferably used for the resistor regions.

### EXAMPLE 1

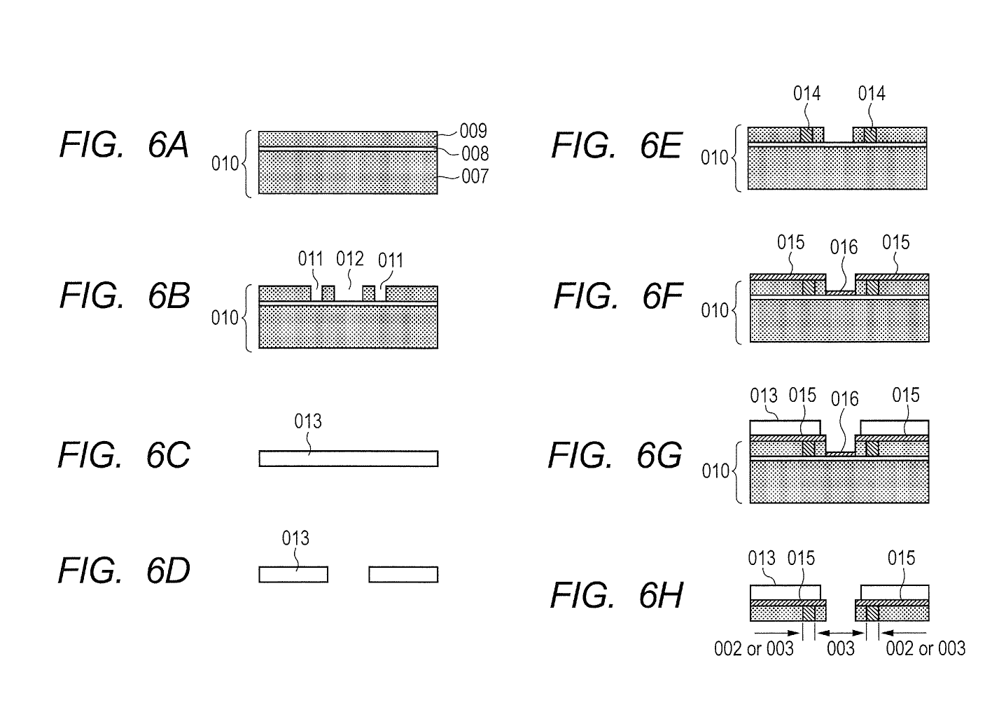

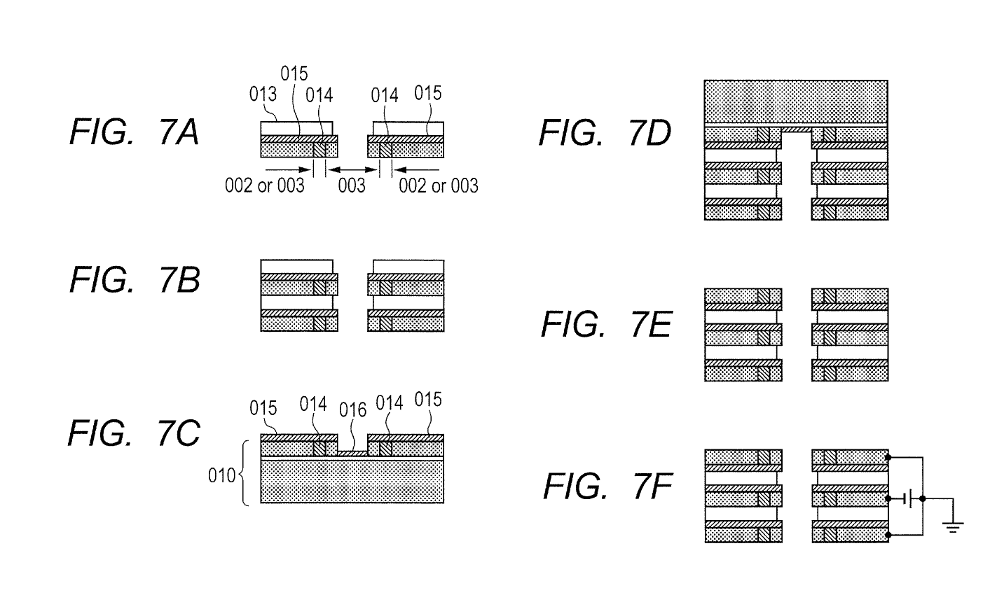

Now, the method of manufacturing the electrostatic lens of Example 1 will be described below by referring to FIGS. 6A through 6H and 7A through 7F.

FIGS. 6A through 6H are schematic cross-sectional views of the electrostatic lens of Example 1, illustrating the flow of the manufacturing process thereof.

Firstly, an electrode material is prepared in an electrode material preparation step illustrated in FIG. 6A.

Si is employed as electrode material and an SOI (silicon on insulator) substrate 010 is brought in to hold the electrodes at the time of forming a dividing section. The SOI substrate has a diameter of 4 inches and includes a handle layer 007 (thickness: 520 μm, resistivity value: 1Ω·cm), a BOX (buried oxide) layer 008 (oxide film layer)(thickness: 5 μm) and a device layer 009 (thickness: 525 μm).

Then, in a dividing section forming step as illustrated in FIG. 6B, a through-hole and a dividing section are formed for an electrode. After forming a pattern mask for forming a through-hole section 012 and a dividing section 011 on the SOI substrate by means of an ordinary photolithography technique, the Si of the device layer 009 is subjected to an etching operation, using a dry etching technique.

While a dry etching technique is employed in this example, the etchant to be used may be a gaseous etchant or a liquid etchant.

Thereafter, a support member 013 is prepared in a support member preparation step as illustrated in FIG. 6C.

As material for the support member 013, a glass substrate having a thickness of 400 μm and a volume resistivity>1×10¹³Ω·cm is employed from the viewpoint of insulation and processability.

Subsequently, a through-hole is formed in the support member 013 in a through-hole forming step as illustrated in FIG. 6D. More specifically, the through-hole is formed by way of a sand blast process, although a through-hole may alternatively be formed in the support member by means of a popularly known through-hole forming technique such as wet etching or drilling.

Then, an insulator 014 is formed in the dividing section 011 in a dividing section insulator forming step as illustrated in FIG. 6E. The insulator 014 is preferably formed by means of an ordinary film forming technique such as CVD, evaporation or sputtering or by means of a coating technique. In this example, spin-on-glass is applied to the dividing section 011 and heat set at 500° C.

Thereafter, a resistor 015 is formed in a resistor forming step as illustrated in FIG. 6F. The resistor 015 is arranged so as to electrically connect region A 002 and region B 003 by means of photolithography. From the viewpoint of resistance control, the material of the resistor 015 is preferably made of an oxide, a nitride or some other compound of a metal such as Al, Ge, Ti or Si or a film mainly containing carbon (e.g., diamond like carbon).

If a material that can be etched by the etchant to be used for etching the BOX layer is selected as the material of the resistor, the resistor 015 in the region 016 and the BOX layer can be removed at the same time.

Such a selection is preferable because, then, the resistor can be formed without using a photolithography step and hence the number of processing steps can be reduced.

In this example, the resistor 015 is formed by using aluminum oxide that dissolves in aqueous solution of ammonium fluoride, which is the etchant to be used for etching the BOX layer, and a reactive sputtering technique. The resistor 015 has a film thickness of 200 nm and a volume resistivity of 1×10⁸Ω·cm.

Then, the electrode (the electrode material having the resistor) is bonded to the support member in an electrode-support member bonding step as illustrated in FIG. 6G. More specifically, the support member formed in the through-hole forming step as illustrated in FIG. 6D and the electrode material, on which the resistor is formed in the resistor forming step as illustrated in FIG. 6F, are bonded to each other by means of an epoxy adhesive agent to be used in vacuum. Alternatively, the electrode material and the support member may be bonded by means of fusion bonding or anodic bonding or by using some other adhesive agent.

Thereafter, the handle layer 007 and the BOX layer 008 are removed in a removal step as illustrated in FIG. 6H.

For removing the Si of the handle layer 007, firstly the handle layer 007 is ground to a thickness of about 50 μm by back grinding and CMP (chemical mechanical polishing). This operation is conducted to reduce the time to be spent in this step and, therefore, may be omitted when the handle layer 007 is sufficiently thin.

Subsequently, the handle layer 007 that is made thin is removed by wet etching using TMAH (tetramethyl ammonium hydroxide), although some other etchant may alternatively be selected from alkaline solutions including KOH solution for this operation instead of TMAH. If dry etching is employed for removing the handle layer 007, the etchant to be used may be selected from etching gases including SF₆, CF₄, CHF₃ and XeF₂.

Subsequently thereafter, the BOX layer 008 is removed by wet etching, using aqueous solution of ammonium fluoride.

However, the etchant to be used for removing the BOX layer may alternatively be selected from aqueous solutions containing hydrofluoric acid.

If the insulator 014 of the dividing section 011 is not resistant against the etching operation, preferably, an appropriate protective film such as SiN film is formed before forming the insulator in the step illustrated in FIG. 6E in order to prevent the insulator 014 from being brought into direct contact with the etchant when removing the BOX layer. “002 or 003” in FIG. 6H means that, when a plurality of through-holes is formed, region B 003 having one or more through-holes may be disposed adjacent to region A 002 or region B 003.

By way of the above-described steps, the process of obtaining a complex member, or an electrode member, by bonding one of the electrodes to one of the support members of an electrostatic lens according to the present invention is completed.

Now, the method of manufacturing the electrostatic lens of this example by using the electrode member formed by way of the steps illustrated in FIGS. 6A through 6H will be described below by referring to FIGS. 7A through 7F.

More specifically, FIGS. 7A through 7F are schematic cross-sectional views in manufacturing steps of an einzel lens to be used for the electrostatic lens of this example. An einzel lens has a three-layered electrode structure. An einzel lens is characterized in that the light receiving end and the light exiting end of the lens are made to represent a same electric potential level. Since the lens does not represent any potential difference between the front end and the back end thereof, an apparatus including such a lens can be formed with ease and hence such a lens is highly versatile.

Firstly, in an electrode member preparation step as illustrated in FIG. 7A, a plurality of electrode members prepared by means of the electrode member manufacturing method described above and illustrated in FIGS. 6A through 6H are brought in.

Then, two of the electrode members are laid one on the other and bonded to each other in an electrode member stacking step as illustrated in FIG. 7B. An epoxy adhesive agent to be used in vacuum is employed for bonding the two electrode members. Alternatively, the electrode members may be bonded by means of fusion bonding or anodic bonding or by using some other adhesive agent.

Then, in a step as illustrated in FIG. 7C, an electrode material on which a resistor is formed in a resistor forming step as illustrated in FIG. 6F is brought in.

The electrode material on which a resistor is formed as illustrated in FIG. 7C is same as the one prepared in the step illustrated in FIG. 6F. Then, in a step as illustrated in FIG. 7D, the stacked body obtained in the electrode member stacking step as described above and illustrated in FIG. 7B and the electrode material that is prepared in the step as illustrated in FIG. 7C and on which a resistor is formed are bonded to each other.

An adhesive agent similar to the one used in the step illustrated in FIG. 7B may also be employed in this step.

Thereafter, the handle layer 007 is removed in a handle layer removing step as illustrated in FIG. 7E. A technique similar to the one employed in the step illustrated in FIG. 6H may also be employed in this step.

In an experiment, as illustrated in FIG. 7F, a 10-kV voltage was applied to an einzel lens prepared by way of the above-described steps and the influence of electric discharges on the service life of the lens was looked in. As a result, the electrostatic lens of this example proved that the degradation of the service life thereof by electric discharges was suppressed if compared with conventional similar einzel lenses that includes only Si electrodes.

A plurality of electrode members, each being prepared by bonding an electrode and a support member as illustrated in FIG. 6H and FIG. 7A, is prepared and stacked in this example. However, an electrode, a support member, an electrode, a support member and so on may sequentially be laid one on the other to produce an electrostatic lens by appropriately and repeatedly executing the steps illustrated in FIGS. 6A through 6H.

Of the above steps, the step of removing the handle layer and the BOX layer as illustrated in FIG. 6H and the resistor forming step as illustrated in FIG. 6F may be executed each time after executing a step of bonding an electrode and a support member or after bonding two electrodes to a support member.

While the lens of this example is manufactured by stacking electrode members that are formed by repeating same manufacturing steps, the functional features of the present invention are left undamaged if a lens is manufactured by stacking electrode members that are prepared to represent different structures and different dimensions.

### EXAMPLE 2

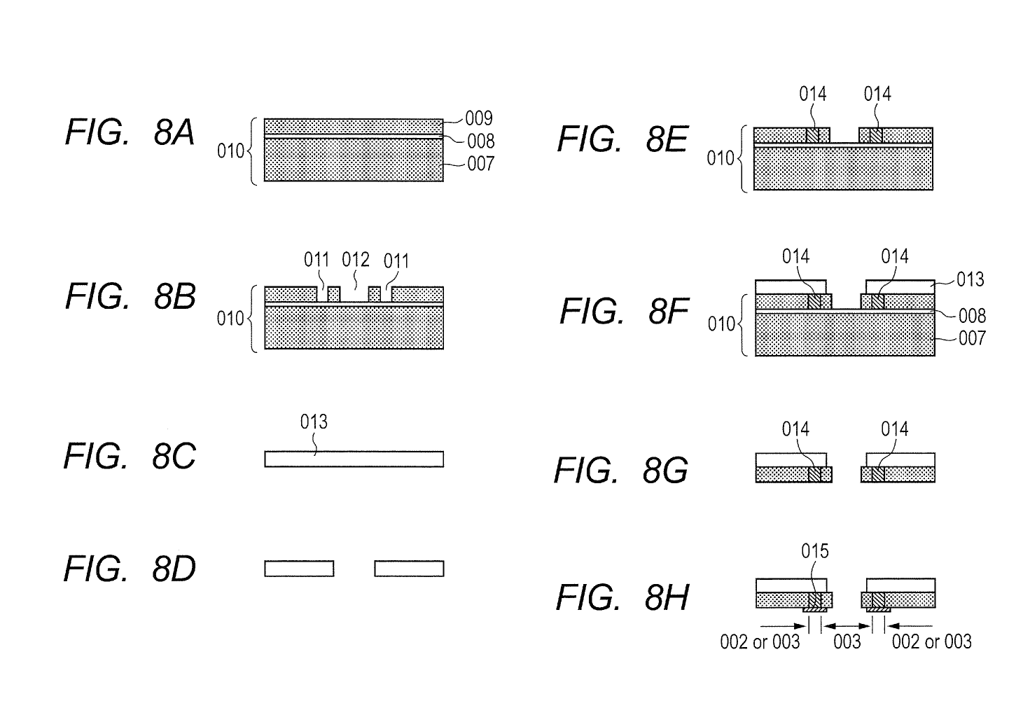

FIGS. 8A through 8H are schematic cross-sectional views of the electrostatic lens of this example in different manufacturing steps, illustrating the method of manufacturing an electrode member by bonding an electrode and a support member.

Since a resistor is formed in the final step in the flow of the manufacturing method, the controllability of the resistance value of the resistor can be improved because the resistor does not need to undergo a plurality of steps after being formed.

The steps illustrated in FIGS. 8A through 8E are same as the steps illustrated in FIGS. 6A through 6E of Example 1 and hence will not be described here repeatedly.

The support member formed in the step of FIG. 8D and the electrode formed in the step of FIG. 8E are bonded to each other in an electrode-support member bonding step as illustrated in FIG. 8F.

At this time, the electrode and the support member are bonded to each other by means of a bonding method referred to as fusion bonding. However, the electrode and the support member may alternatively be bonded by anodic bonding or by means of an adhesive agent.

Then, the handle layer 007 and the BOX layer 008 are removed in a removal step as illustrated in FIG. 8G by means of a technique similar to the technique used in the step of FIG. 6H of Example 1.

Thereafter, a resistor 015 is formed in a resistor forming step as illustrated in FIG. 8H.

The resistor 015 is arranged so as to electrically connect the region A 002 and the region B 003 by means of photolithography. The material of the resistor 015 is preferably made of an oxide, a nitride or some other compound of a metal such as Al, Ge, Ti, Si or a film mainly containing carbon (e.g., diamond like carbon) from the viewpoint of controlling the resistance value of the resistor.

If insulator 014 is found in the region exposed to irradiation of electron beams, the resistor 015 is preferably so formed as to completely cover the insulator 014 in order to prevent the insulator 014 from being electrically charged.

AlN film is formed as the resistor 015 by reactive sputtering of aluminum in a nitrogen atmosphere.

The formed AlN film has a film thickness of 200 nm and a volume resistivity of 1×10⁷Ω·cm. By way of the above-described steps, the process of obtaining one of the electrodes and one of the support members of an electrostatic lens according to the present invention is completed.

### EXAMPLE 3

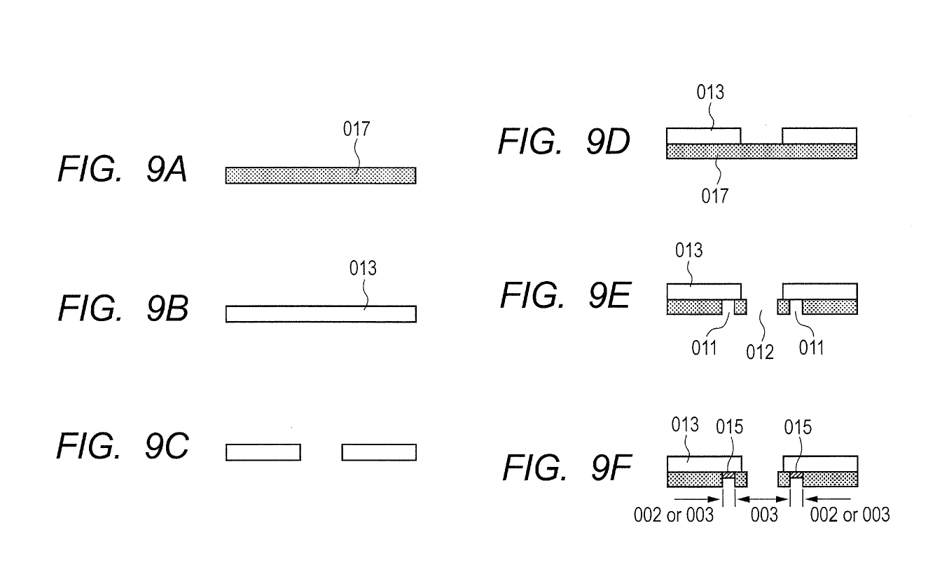

FIGS. 9A through 9F are schematic cross-sectional views of the electrostatic lens of this example in different manufacturing steps, illustrating the method of manufacturing an electrode member by bonding an electrode and a support member. In this example, expensive SOI is not used for forming electrodes and wafer Si is employed instead to reduce the manufacturing cost.

An electrode material is brought in for an electrode material preparation step as illustrated in FIG. 9A.

In this example, a silicon wafer 017 having a film thickness of 525 μm and a volume resistivity of 0.1Ω·cm is employed as electrode material.

Then, a support member preparation step as illustrated in FIG. 9B is executed. This step is similar to the step of Example 1 as illustrated in FIG. 6C.

Subsequently, a through-hole forming step as illustrated in FIG. 9C is executed. This step is similar to the step of Example 1 as illustrated in FIG. 6D.

Thereafter, the electrode and the support member are bonded to each other in an electrode-support member bonding step as illustrated in FIG. 9D. At this time, the electrode and the support member may be bonded to each other by means of fusion bonding or anodic bonding or by using some other adhesive agent as in the case of the step of FIG. 6G of Example 1.

The electrode and the support member are bonded to each other by fusion bonding in this example. When bonding them to each other by means of an adhesive agent, care should be taken to apply the adhesive agent appropriately so that both the region A 002 and the region B 003 are surely bonded to the support member after dividing the electrode into two regions.

Then, a dividing section forming step for forming a through-hole and a dividing section in the electrode as illustrated in FIG. 9E is executed. This step is similar to the dividing section forming step of Example 1 as illustrated in FIG. 6B.

Finally, a resistor forming step as illustrated in FIG. 9F is executed. This step is similar to the resistor forming step of Example 1 as illustrated in FIG. 6F.

By way of the above-described steps, the process of obtaining one of the electrodes and one of the support members of an electrostatic lens according to the present invention is completed.

### EXAMPLE 4

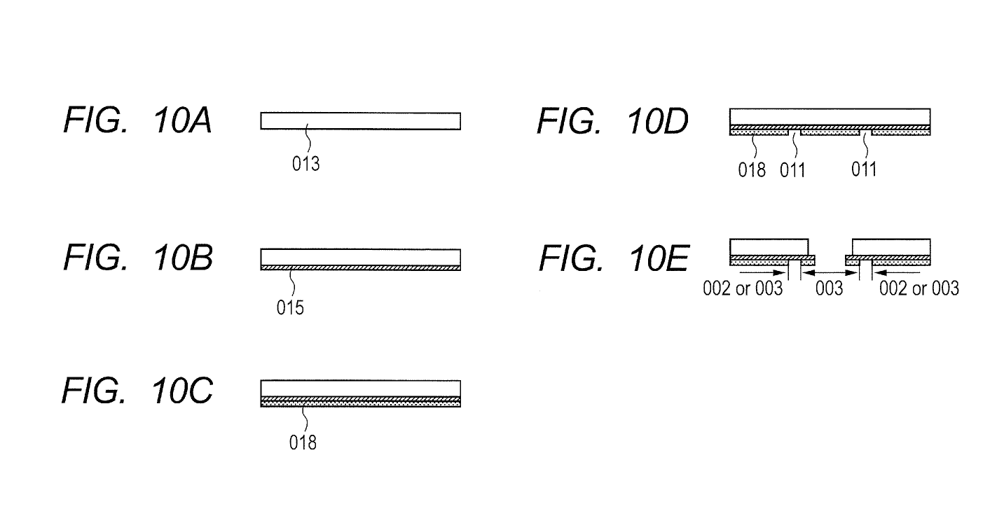

FIGS. 10A through 10E are schematic cross-sectional views of the electrostatic lens of this example in different manufacturing steps, illustrating the method of manufacturing an electrode member by bonding an electrode and a support member.

Since a film of a conductive material is formed on a support member to produce an electrode in this example, the electrostatic lens of this example can be manufactured with a reduced number of manufacturing steps and a reduced number of component members, which leads to a low manufacturing cost.

Firstly, a support member is prepared in a support member preparation step as illustrated in FIG. 10A. This step is similar to the support member preparation step of Example 1 as illustrated in FIG. 6C.

Then, a resistor is formed in a resistor forming step as illustrated in FIG. 10B.

An AlN film is formed by means of reactive sputtering.

However, an oxide, a nitride or some other compound of a metal such as Al, Ge, Ti or a film mainly containing carbon (e.g., diamond like carbon) may alternatively be used as in the case of the corresponding step of Example 1 as illustrated in FIG. 6F.

The formed AlN film has a film thickness of 200 nm and a volume resistivity of 1×10⁷Ω·cm. Then, an electrode (electrode section 018) is formed in an electrode forming step as illustrated in FIG. 10C.

The electrode is formed by using Si and CVD. Alternatively, a metal material having a high conductivity such as Cr, Mo, Cu or Au may alternatively and suitably be used.

The formed Si film has a film thickness of 1 μm and a volume resistivity of 1×10¹Ω·cm.

Then, a dividing section 011 is formed in a dividing section forming step as illustrated in FIG. 10D.

A groove (dividing section) 011 is formed in an electrode section 018 by way of an ordinary photolithography process. TMAH is employed as etchant. Alternatively, however, the etchant to be used may be a gaseous etchant or a liquid etchant.

Thereafter, a through-hole 004 is formed in a through-hole forming step as illustrated in FIG. 10E.

Then, a through-hole running all the way through the support member 013, the resistor 015 and the electrode section 018 is formed by way of an ordinary photolithography process, using an etchant, which is either KOH or BHF (buffered hydrogen fluoride), although the etchant that can be used in this step is not limited to the above-cited ones and some other etchant that may be a gaseous etchant or a liquid etchant may alternatively be employed. Still alternatively, a through-hole 004 may be formed by way of a machining process such as a drilling process.

When a through-hole is formed by way of a machining process, the wall surface profile of the through-hole can suitably be improved by additionally executing an etching process, using a gaseous or liquid etchant.

Einzel lenses were prepared respectively by using the lens members prepared by way of the above-described manufacturing steps of Examples 2 through 4 and the influence of electric discharges on the service lives of the einzel lenses were examined by applying a voltage of 10 kV to each of the lenses as in the case of Example 1. As a result, the electrostatic lenses of these examples proved that the degradation of the service lives thereof by electric discharges was suppressed if compared with conventional similar einzel lenses that includes only Si electrodes.

Thus, the present invention can realize an electrostatic lens that can suppress the discharge current that flows at the time of an electric discharge, thereby suppressing the degradation of the lens members such as an electrode and an electrode member, so as to provide an improved reliability for the lens, and also a method of manufacturing such a lens.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-135672, filed Jun. 15, 2012, which is hereby incorporated by reference herein in its entirety.

What is claimed is:

1. An electrostatic lens comprising:
a first electrode; and
a second electrode;
the first electrode and the second electrode being arranged oppositely relative to each other with a gap separating them from each other;
the first and second electrodes having respective through-holes for allowing a charged particle beam to pass through the through-hole,
at least either the first electrode or the second electrode comprising two or more regions;
the through-hole of the electrode with the two or more regions being arranged at least in one of the regions;
the regions being electrically connected to each other by way of a resistor.

2. The electrostatic lens according to claim 1, wherein
the resistor is arranged in a portion disposed between the regions.

3. The electrostatic lens according to claim 1, wherein
an insulator is arranged between the first electrode and the second electrode.

4. The electrostatic lens according to claim 3, wherein
the resistor is arranged at least either between the first electrode including the regions and the insulator or between the second electrode including the regions and the insulator.

5. The electrostatic lens according to claim 1, wherein
the resistor is made of a material representing a resistivity greater than the material of the first electrode and the second electrode.

6. A method of manufacturing an electrostatic lens having two or more electrodes stacked with a support member interposed between adjacent ones of the electrodes, each of the electrodes and the support member(s) having respective through-holes for allowing a charged particle beam to pass through the through-hole, the method comprising:
a dividing section forming step of forming a through-hole for allowing a charged particle beam to pass through the through-hole in an electrode material and forming a dividing section for dividing the electrode material into two regions, the dividing section being disposed between the two regions;
a resistor forming step of forming a resistor for electrically connecting the two regions produced as a result of the division by the dividing section;
a through-hole forming step of forming a through-hole for allowing a charged particle beam to pass through the through-hole, in a support member to be arranged between two electrodes;
a step of forming an electrode member by bonding the electrode material having the resistor formed in the resistor forming step, and the support member; and
a step of stacking a plurality of electrode members, each being formed by way of the above steps of forming an electrode member.

7. The method of manufacturing an electrostatic lens according to claim 6, wherein
the electrode material is SOI having a handle layer, a BOX layer and a device layer; and
the through-hole and the dividing section are formed by etching the device layer in the dividing section forming step, while
in the step of forming an electrode member, the electrode member is formed by removing the handle layer and the BOX layer after bonding the electrode material in which the resistor is formed and the support member.
